(19) United States
(12) Patent Application Publication
(10) Pub. No.: US 2008/0109941 A1
(43) Pub. Date: May 15, 2008

(54) THIN FILM ENERGY FABRIC INTEGRATION, CONTROL AND METHOD OF MAKING

(75) Inventor: Wylie Moreshead, Bainbridge Island, WA (US)

Correspondence Address: SEED INTELLECTUAL PROPERTY LAW GROUP PLLC, 701 FIFTH AVE, SUITE 5400, SEATTLE, WA, 98104, US

(73) Assignee: Energy Integration Technologies, Inc., Bainbridge Island, WA (US)

(21) Appl. No.: 11/972,577

(22) Filed: Jan. 10, 2008

Related U.S. Application Data
(63) Continuation-in-part of application No. 11/439,572, filed on May 23, 2006.
(60) Provisional application No. 60/684,890, filed on May 26, 2005.

(51) Int. Cl. A41D 31/02; B32B 5/00; B32B 37/00

(52) U.S. Cl. 2/243.1; 428/105; 156/166

(57) ABSTRACT

A material that includes a first section for storing energy and a second section for collecting and converting energy for storage by the first section in which the stored energy is preferably electrical energy that is used for one from among heat dissipation, heat generation, light emission and powering of an electric circuit in a plurality of devices, ideally covered with a layer to form at least one self-contained panel for operation independently or with other panels to form a system. The material can be formed of layers having devices or components embedded therein, the layers preferably laminated together using a battened pattern of adhesion. A control bus system allows master or slave designation as well as power sharing to the individual panels in the garment as well as among garments.

### CROSS-REFERENCE TO RELATED APPLICATION

This application is a continuation-in-part of U.S. patent application Ser. No. 11/439,572, filed May 23, 2006, now pending, which application is incorporated herein by reference in its entirety.

### BACKGROUND OF THE INVENTION

1. Field of the Invention

The present invention is directed to thin, flexible material and, more particularly, to a flexible fabric having electrical energy storage and release capabilities integrally formed therewith.

2. Description of the Related Art

There are currently materials that incorporate energy releases in the form of light or heat and are powered by some external, rigid power source.

For example, Coler et al., U.S. Pat. No. 3,023,259, describes a flexible battery that is designed, in one embodiment, to wrap around a person under their clothing so that body heat may be utilized to maintain the electrochemical temperature within a preferred temperature range. The flexible battery includes a flexible electrode that incorporates a wire mesh selected of a metal non-reactive with components of the electrochemical system. A coating composition is provided that includes an active electrode material, electrically conductive particles, and a synthetic resin binder. Coler et al. teach the use of heat to maintain the flexible battery within a preferred operating temperature range.

Armbruster, U.S. Pat. No. 3,535,494, illustrates the use of metal foil material that is flexible and includes a layer of plastic material and small particles of electrically conductive material substantially uniformly distributed throughout the layer of plastic material. A low voltage supply provides electric current that passes in a direction substantially normal to opposing faces through the sheet material and in which the sheet material and the metal foils thereto are sandwiched between a pair of plastic sheets to form with the latter a flexible heating unit.

Romaniec, U.S. Pat. No. 3,627,988, describes electrical heating elements utilizing conducted carded fibrous carbon web having flexible electrodes and a supporting layer of loosely woven fabric overlying and united with each face of the web.

Lehovec et al., U.S. Pat. No. 4,470,263, is entitled “Peltier-Cooled Garment” that attaches to a garment and having a cold plate bearing against the skin of a user. Heat collected by the cold plate is distributed through fins.

Triplett et al., U.S. Pat. No. 4,700,054, describe electric devices formed of a fabric prepared from at least one electrode and a substance of high resistance and to include a conductive polymer. The positive temperature coefficient of the resistance material has a resistivity that increases by a factor of at least 2.5 over a temperature range of 14° C. or by a factor of at least 10 over a temperature range of 100° C., and preferably both.

Nagatsuka et al., U.S. Pat. No. 5,242,768, is directed to a three-dimensional woven fabric for use inside of a battery. The fabric material itself is not a battery and would be incapable of storing electricity. It is designed to be used in a seawater battery containing an electrolyte.

Schneider et al., U.S. Pat. No. 5,269,368, is directed to a rechargeable temperature regulating device for controlling the temperature of a beverage or other object that utilizes fluid housed in a flexible jacket having an inner chamber. The jacket is recharged in a freezer or heated in a microwave, depending on the function to be performed.

Jones, U.S. Pat. No. 6,049,062, describes a heated garment with a temperature control that is worn on the body of an individual. The thermal garment includes an interior liner with a heating element disposed in the interior liner of the garment. The heating element is disposed within a majority of the area of the garment, and at least one flexible rechargeable battery is disposed within the interior liner of the thermal garment. A thermostat within the outer layer of the thermal garment and in communication with the heating element regulates the temperature.

Aisenbray, U.S. Publication No. 2004/0188418, discloses low cost heating devices manufactured from conductive loaded resin-based materials. Micron conductor fibers are provided, preferably of nickel plated carbon fiber, stainless steel fiber, copper fiber, silver fiber, or the like. Conductive loaded resin-based heating devices can be formed using methods such as injection molding, compression molding, or extrusion. The conductive loaded resin-based material that forms the heating devices can also be in the form of a thin flexible woolen fabric that can be readily cut to the desired shape.

Knoerzer, U.S. Pat. No. 6,637,906, discloses a flexible electroluminescent (EL) film that incorporates the battery directly into the thin film layer structure and would be used for lighted product packaging. The EL films or thin film electroluminescents (TFELs) described by Knoerzer are inorganic and consist of phosphor particles that illuminate when energized by electrical current. Knoerzer describes an inverter to change DC current from the battery into AC current which is used to illuminate the EL film. With the introduction of organic light emitting polymers (LEPs) and organic light emitting diodes (OLEDs), which are organic polymers, not phosphor films, there is no need for an inverter system, which is problematic to integrate into a completely flexible system. The manufacture of the organic polymers also presents several processing advantages over an inorganic EL film.

However, there is currently no single fabric available to the engineer or designer that has the electrical energy storage aspect directly integrated into it and is still thin, flexible, and can be manufactured into a product with the same ease as conventional fabrics. Hence, there is a need in this day and age for such a fabric that also has all the normal characteristics of a modern engineered fabric, such as waterproof, breathability, moisture wickability, stretch, color and texture choices. So far no fabric has emerged with all these characteristics.

### BRIEF SUMMARY OF THE DISCLOSURE

The disclosed embodiments of the present disclosure are directed to a fabric with all the characteristics of a modern engineered fabric, such as water resistance, waterproofness, moisture wickability, breathability, stretch, color, and texture choices, along with the ability to store electrical energy and release it to provide heating, cooling, lighting, and other uses of electrical energy. In addition, in one form of the invention there is the option of taking energy from its surroundings, converting it to electrical energy, and storing it inside the fabric for later use. Thin film deposition technology, polymer technology, MEMs, and new engineered materials enable production of a fabric with all the above characteristics.

In one embodiment, a material is provided that includes a first flexible section configured to store energy; a second flexible section coupled to the first section and configured to release the stored energy contained in the first section; and a plurality of devices embedded in the material and coupled to the first section to utilize the stored energy. In one aspect a controller is coupled to the plurality of devices, ideally in a master-slave arrangement. It should be noted that these sections and devices can be arranged coplanar or layered as long as the sections are continually connected or enveloped together.

In accordance with another aspect of the present disclosure, the material includes one or more properties of semi-flexibility or flexibility, water resistance or waterproofness, and formed as a thin, sheet-like material or a thin woven fabric.

In accordance with another aspect of the present disclosure, the material is formed from strips of material having the characteristics described above that are woven together to provide a thin, flexible material that can utilized as a conventional fabric, such as inner or outer clothing worn by a user or as a component used in footwear such as an insole or a specialized fabric panel.

In accordance with another aspect, a third section is coupled to the first section, and the third section is configured to receive energy and convert the energy into electrical energy for storage in the first section or for use by the second section and the plurality of devices. In one aspect, the first, second, and third sections and the plurality of devices are laminated between protective layers that are adhered together to form adhesive battens.

In accordance with another embodiment of the disclosure, a flexible garment is provided that includes a first flexible layer adapted to store electrical energy; and a second flexible layer coupled to the first layer and configured to release the stored energy contained in the first section; a plurality of devices in the garment adapted to utilize the electrical energy from the first layer, the devices and the second layer comprising a combination of at least two from among heat dissipation, heat generation, light emission, and an electric circuit; and a layer formed on the first, second, and third layers along with the plurality of devices to form a single panel or multiple connected panels.

In accordance with another aspect, the garment includes a bus coupled to the at least one panel to enable the at least one panel to perform as one of a master panel and a slave panel.

In accordance with another embodiment, a garment is provided that includes a flexible material comprising a first section configured to store energy and a second section configured to release energy received from the first section. Ideally, the material of the garment includes a third layer adapted to obtain energy and convert the obtained energy to electrical energy for storage in the second section. Ideally, a control circuit is coupled to the plurality of devices and to the first and second layers and adapted to provide selective control of operation of the plurality of devices. In one embodiment, the control circuit is formed with one of the plurality of devices to provide a master device and the remaining of the plurality of devices are slave devices. Preferably, in another embodiment the devices are embedded between the first and second sections.

In accordance with still yet a further embodiment, a method of providing a flexible fabric material is disclosed, the method includes providing a flexible fabric material adapted to be formed from a first flexible layer adapted to store electrical energy and a second flexible layer electrically coupled to the first flexible layer and adapted to receive the stored energy from the first flexible layer for use in at least one from among heat dissipation, heat generation, light emission, and powering of an electric circuit, the method including laminating at least one device and the first and second layers with at least one lamination layer.

In accordance with further aspects of the method, at least one roller is utilized to laminate the layers, the roller having a surface geometry adapted to remove air from between the layers as the lamination process occurs and to not damage the embedded components and the layers. In accordance with another aspect, the layers are adhered together in a manner that forms adhesive battens within the laminate. The layers and the components are, in further embodiments, arranged to be either coplanar or stacked in relationship to one another.

In accordance with another embodiment of the present disclosure, a device is provided that includes a first flexible layer adapted to store electrical energy; a second flexible layer coupled to the first layer and configured to release the stored energy in the first layer; and a plurality of devices adapted to utilize the electrical energy from the first layer, the devices and the second layer comprising a combination of at least two from among heat dissipation, heat generation, light emission, and an electric circuit; a layer that covers the first and second layers along with the plurality of devices coupled to at least one of the second layer and the first layer to form at least one of a single panel and multiple connected panels; and a bus to enable distribution of energy to at least one of the panels in the garment.

In accordance with another aspect of the present disclosure, the device includes a connection of multiple panels to form a connected system through the bus connection system. In another aspect, a connection of multiple garments is provided to form a connected system through the bus connection system.

In accordance with yet another embodiment of the disclosure, a garment system is provided that includes a plurality of garments, each garment having at least a portion thereof formed of a first flexible section adapted to store electrical energy; a second flexible section coupled to the first section and configured to release the stored energy contained in the first section; at least one device in at least one garment adapted to utilize the electrical energy from the first section, the at least one device and the second section comprising a combination of at least two from among heat dissipation, heat generation, light emission, and an electric circuit; a layer that covers the first and second sections along with the at least one device to form at least one of a single panel and a plurality of panels that are connected together; and a bus coupled to the at least one of a single panel and the plurality of panels to enable the at least one of a single panel and the plurality of panels to perform as one of a master panel and a slave panel and to enable sharing of electrical energy among the garments.

In accordance with another aspect, the garment system includes a local control device in each garment adapted to enable selection of a mode of operation of the associated garment apart from other garments in the system.

### BRIEF DESCRIPTION OF THE SEVERAL VIEWS OF THE DRAWINGS

The foregoing and other features and advantages of the present invention will be more readily appreciated as the same become better understood from the following detailed description when taken in conjunction with the accompanying drawings, wherein:

FIG. 1 is an isometric illustration of a first embodiment of a material formed in accordance with the present invention;

FIG. 2 is an isometric illustration of another embodiment of a sheet-like material formed in accordance with the present invention;

FIG. 3 is an isometric illustration of a yet a further embodiment of a thin film fabric formed in accordance with the present invention;

FIG. 4 is an isometric illustration of yet another embodiment of the present invention showing energy flow into and out of the fabric;

FIG. 5 illustrates the flow of energy between panels in related garments;

FIGS. 6A-6B illustrate control routing among various garments denoted as “master” and “slave;”

FIGS. 7-8 illustrate power and control bus connections for system and local master and slave devices, respectively;

FIG. 9 illustrates embedded electronic components in film substrates;

FIGS. 10-11 illustrate two batten forming adhesive patterns; and

FIG. 12 illustrates the use of registration points in assembling components of energy textile panels.

### DETAILED DESCRIPTION

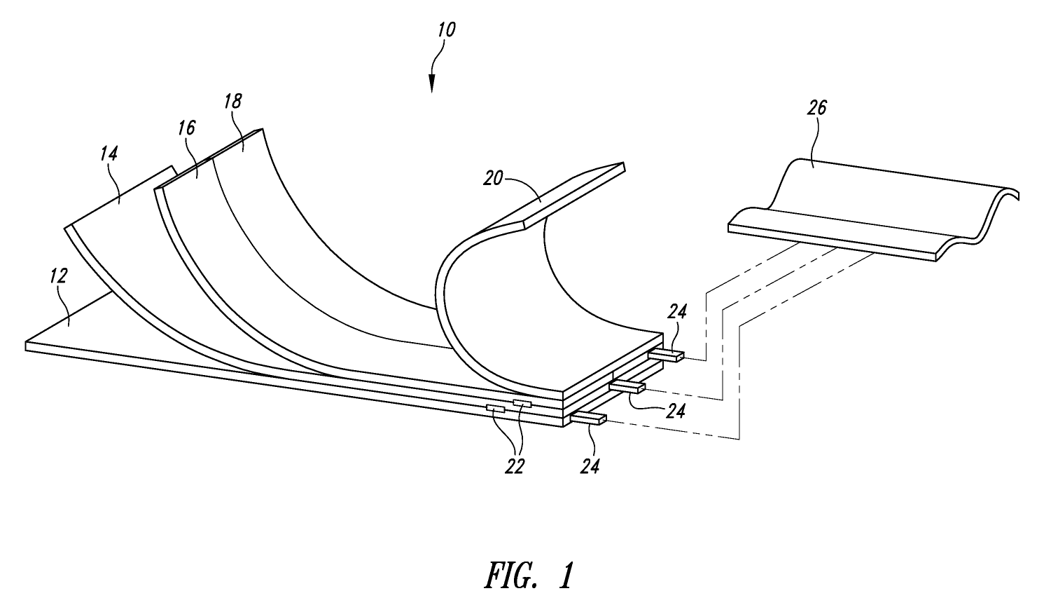

Referring initially to FIG. 1, shown therein is a flexible sheet 10 formed in accordance with one embodiment of the disclosure.

FIG. 1 serves to diagrammatically illustrate the flexible sheet form of the finished energy fabric 10 that includes an energy release section 12 and an energy storage section 14. An optional charge section 16 or recharge section 18 or combination thereof is shown along with an optional protective section 20 that can also be a decorative section. These sections can be manufactured separately and then laminated together or each section can be directly deposited on the one beneath it or a combination of both techniques can be employed to produce the final fabric. These sections can be arranged in any order including coplanar arrangements, layers, planes, and other stacking arrangements, and there can be multiple instances of each section in the final fabric.

The sections can also have different embodiments on the same plane. For instance, a section of the charge or recharge plane 16,18 can use photovoltaics while another section can use piezoelectrics or a section of the energy release plane can produce light while another section can produce heat. Similarly, one section of the plane can produce light while another section on the same plane can use photovoltaics to recharge the energy storage section. Some sections must be connected electrically to some of the other sections. This can be done with the contact occurring at certain points 22 directly between the sections or with the contact occurring though leads 24 that connect via a remote PCB 26, thus providing operator input, monitoring, and control capabilities. Although not required, the PCB 26 can be built on a flexible substrate as can the leads 24, and the PCB 26 can control multiple separate fabric instances simultaneously using control methods and devices known in the art and which will not be described in detail herein. Briefly, controls such as fixed and variable resistance, capacitance, inductance, and combinations of the forgoing, as well as software and firmware embodied in corresponding hardware can be implemented to regulate voltage and current, phase relationships, timing, and other known variables that ultimately affect the output. Regulation can be user controlled or automatic or a combination of both

The leads 24 that connect the sections can, but do not have to be, connected to the remote PCB 26. All lead connections should be sealed at the point of contact to provide complete electrical insulation. The flexible PCB 26, which contains circuits, components, switches and sensors, can also be integrated directly into the final fabric as another section, coplanar or layered, and so can the leads.

One method of manufacturing the individual sections into a custom, energized textile panel would consist of: 1) locating the energy storage, energy release and possibly energy recharge sections adjacent to or on top of one another (depending on panel layout and functionality) 2) electrically interconnecting the various sections by affixing thin, flexible circuits to them that would provide the desired functionality and then 3) laminating this entire system of electrically integrated sections between breathable, waterproof films. The preferred materials in the heating embodiment of a panel would consist of lithium polymer for the energy storage section, PTC heaters for the energy release section, piezoelectric film for the recharge section, copper traces deposited on a polyester substrate for the thin, flexible electrical interconnects and a high Moisture Vapor Transmission Rate polyurethane film as the encapsulating film or protective section. While cloth material can be used, preferably it would be laminated over the encapsulant film. The cloth could be any type of material and would correspond to the decorative section as described herein. The type of cloth would completely depend on the desired color, texture, wickability, and other characteristics of the exterior of the panel.

A thin film, lithium ion polymer battery, such as manufactured by Gaston Narada, Voltaflex, Solicore, Sanyo, Cymbet, Excellatron, Valence, Amperex or Enderel, is an ideal flexible thin, rechargeable, electrical energy storage section. Each consists of a thin film anode layer, cathode layer, and electrolytic layer, and each battery forms a thin, flexible sheet that stores and releases electrical energy and is rechargeable. Carbon nanotubes are now also being used by Advanced Battery Technologies, Inc., in conjunction with the lithium polymer battery technology to increase capacity and are integrated into the final fabric in the same manner as would a standard polymer battery. It should be noted that the energy storage section should consist of a material whose properties do not degrade with use and flexing. In the case of lithium polymers, this generally means the more the electrolyte is plasticized, the less the degradation of the cell that occurs with flexing.

Another technology that can be used for the energy storage section is a supercapacitor or ultracapacitor of the types being developed and manufactured by Skeleton Technologies, Cooper Electronic Technology's PowerStor Aerogel, and Telcordia Technologies. These types of supercapacitors use different technologies to achieve a thin, flexible, rechargeable energy storage film and are good examples in the ultra- and super-capacitor industry as to what is currently available commercially for integration and use.

Thin film micro fuels cells of different types (PEM, DFMC, solid oxide, MEMS and hydrogen) are also becoming available from companies such as NEC, Toshiba, Millennium Cell, MTI Micro and Nippon Telegraph and Telephone Corporation that can be laminated into the final fabric to provide an integrated power source to work in conjunction with (hybridized), or in place of, a thin film battery or thin film capacitor storage section.

In the energy release section there are several embodiments, including but not limited to heating, cooling and light emission.

For the heating embodiment, a normal thin wire or etched thin film resistance heater as manufactured by Minco, Birk Manufacturing, Tempco or Qfoil by ECG Enterprises, Inc., works well. A PTC or positive temperature coefficient resistive heater as manufactured by Conductive Technologies, Thermo, or ITW Chronotherm also works very well for a thin film, self-regulating, heater section. In the case of the PTC, its heater is built to regulate itself specifically to a temperature determined before manufacture. This means that the resistive heating element changes it's resistance depending on the instantaneous temperature of the heater without the use of sensors and added circuitry. All these heating elements are deposited on a thin flexible substrate, usually kapton or polyester, which can then be laminated with or without an adhesive to the other fabric sections, or the heating elements can be directly deposited on an adjoining fabric section. For instance, the heater element can be deposited directly on the packaging layer of a lithium polymer battery and then covered with a thin film of polyester, kapton, urethane or some other thin flexible material to encapsulate and insulate the heating element or fabric section or both.

For the cooling embodiment of the energy release section, a thin film, superlattice, thermoelectric cooling device, such as being developed and produced by ITR international, is ideal for integration into the final fabric. Being a thin film device, it can be deposited using another of the fabric sections as it's substrate, or it can be deposited on a separate substrate and then laminated with or without an adhesive to the other existing fabric sections.

For the light emitting embodiment of the energy release sections, there are many organic polymer-based thin film technologies available for integration into the fabric. Organic light emitting diodes (OLEDs) manufactured by OSRAM, Cambridge Display Technologies, and Universal Display Corporation are polymer-based devices that are manufactured in thin, flexible, sheet form and can be powered directly from a DC power source without an inverter. Some other examples of applicable organic, flexible, light emitting technologies that use DC power without an inverter include polymeric light emitting diodes (PLEDs) manufactured by Cambridge Display Technologies, light emitting polymers (LEPs) also manufactured by Cambridge Display Technologies, Electronic Ink manufactured by E-Ink and flexible liquid crystal displays (LCDs) currently being developed and manufactured by Sarnoft, Softpixel, Samsung and Toshiba. The light emitting embodiment of the fabric can be used to display a static lit design or a changing pixilated display. Being thin film devices, all these technologies can be deposited using another of the fabric sections as their substrate or they can be deposited on separate substrates and then laminated with or without adhesives to the other existing fabric sections.

There are many currently available options for the charge and recharge section in it's several embodiments. In the embodiment using light energy to charge or recharge the energy storage section, several photovoltaic manufacturers, such as ETA Engineering's Unisolar and Iowa Thin Film Technology's Powerfilm, produce thin, flexible photovoltaic cells.

In the embodiment using fabric flexure and piezoelectric materials to generate electricity for storage in the energy storage section, companies such as Continuum's PiezoFlex, Mide's Poweract, Measurement Specialties' Piezo Film and Advanced Cerametrics Incorporated produce films that are easily laminated and electrically integrated into the final fabric

In the embodiment using a magnetic, inductive or wireless charging system to produce electrical energy for storage, companies such as Splashpower and Salcomp currently manufacture technology that can be laminated and electrically integrated into the final fabric.

It should also be noted that in the case of a thermoelectric (Peltier), or photoelectric (photovoltaic) section that is used as an energy release component, this section can also be used in a reversible fashion as a energy recharging section for the energy storage section(s). For example, if a system is producing a large amount of excess heat energy, say in the case of a garment used during high aerobic activity, that heat energy can be converted by the thermoelectric section to electricity for storage in the energy storage section(s) and then used reversibly back through a thermoelectric section for heating when there is an absence of heat after the aerobic activity has stopped. The same sort of energy harvesting technique could be used by the photoelectric (photovoltaic) sections to produce light when there's an absence of it and also to transform the light energy to electrical energy for storage in the energy storage sections when there is an excess of it. In the case of the piezoelectric embodiment, electrical energy can be created and stored during flexing and then used reversibly to stiffen the piezoelectric section if a stiffening of the fabric is required. This text describes only a few embodiments of the reversible fabric sections whereas there are many possible section permutations within the embodiments described.

There are many available products that can be used for the protective and decorative section(s). Malden Mills is a good example of a supplier that has a broad product line with many applicable products. For example their product line includes sections that are engineered for next-to-skin wickability, fibrous, fleece-type comfort, water repellency, specific color, specific texture and many other characteristics that can be incorporated by laminating that section into the final fabric. There are also many ThemoPlastic Urethanes (TPUs) available for use as sealing and protective envelopes. These materials exhibit very high Moisture Vapor Transmission Ratios (MVTRs) and are extremely waterproof allowing the assembled energy storage, release and recharge sections to be enveloped in a highly breathable, waterproof material that also provides a high degree of protection and durability. Some companies currently manufacturing these TPUs are American Polyfilm, Inc. (API), Onmiflex, and Noveon. In addition to the TPUs, which are a solid monolithic structure, there are also microporous materials that are available for use as breathable, waterproof sealing and protective envelopes. This microporous technology is commonly found in Gore products and can also be used in conjunction with TPUs.

It should also be noted that when laminating these breathable waterproof envelopes around the assembled sections, care must be taken, whether using an adhesive or not, to maintain the breathability of the laminate. If adhesive is being used, this adhesive must also have breathable characteristics. The same applies to a laminate process that does not use adhesive. Whatever the adhesion process is, it needs to maintain the breathability and waterproofness of the enveloping protective section, providing these are traits deemed necessary for the final textile panel.

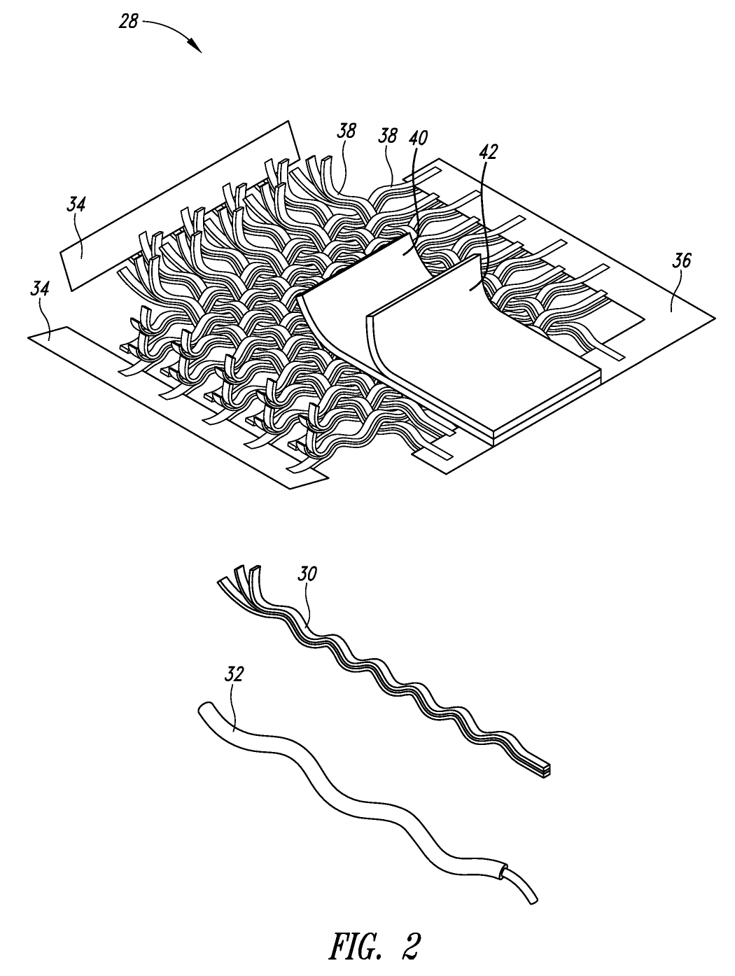

FIG. 2 illustrates the highly flexible woven form of a finished energy fabric 28 that includes woven strips 30 where each individual strip contains an energy release section, an energy storage section and an optional charge\recharge section. The strips 30 would not necessarily need to be constructed with rectangular sections; they can also be constructed with coaxial sections 32. The strips 30 can, but would not have to all be, electrically connected at the edge 34 of the fabric 28 with similar contacts 36 on the warp and weft of the weave being isolated at the same potential as applicable for the circuit to function. All of the strips 30 do not necessarily have to have the same characteristics. For instance, strips with different energy release embodiments can be woven into the same piece of fabric as shown at 38.

An optional treatment or sealing section 40 can be deposited on one or both sides of the final fabric 28 to facilitate the waterproof and breathability properties of the fabric. This enveloping section keeps liquid water from passing through but allows water vapor and other gases to move through it freely. This type of deposition is well known to those skilled in the art and will not be described in more detail herein. An excellent example would be the proprietary layers applied to GoreTex® fabric to make it waterproof and breathable. It should be noted there are many alternative coatings to GoreTex® currently commercially available, including ThermoPlastic Urethanes such as the ones manufactured by API, Omniflex, or Noveon. An optional protective or decorative section 42 can also be added to change external properties of the final fabric such as texture, durability, stretchability or moisture wickability.

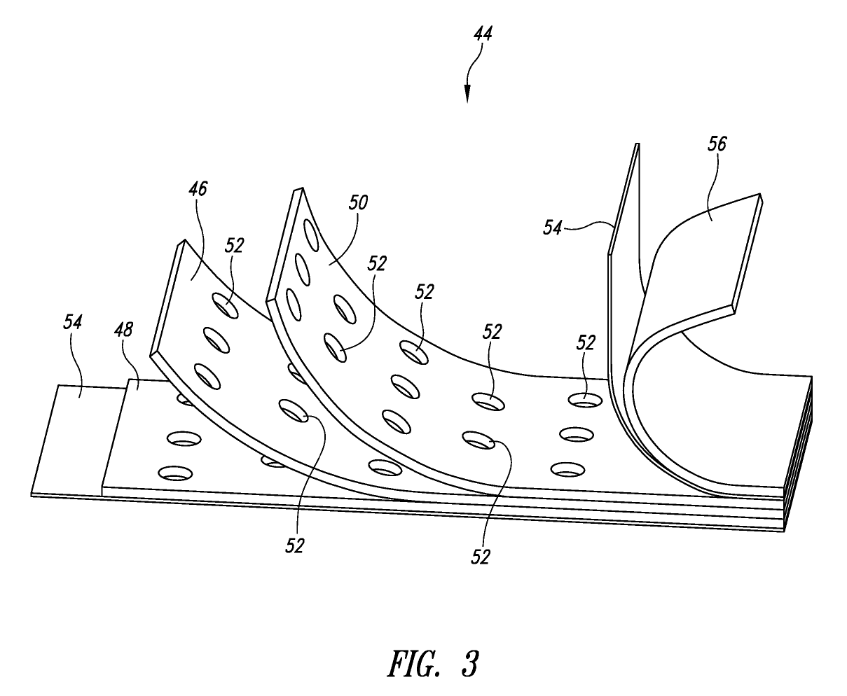

FIG. 3 illustrates a highly flexible sheet 44 consisting of an energy storage section 46, an energy release section 48, and an optional charge or recharge section 50, all patterned with openings 52 to impart traits such as breathability and flexibility to the final fabric. These openings or holes 52 in the fabric 44 can be deposited in a pattern for each section, with the sections then laminated together such that the patterns line up to provide an opening through the fabric covered only by a treatment or sealing enveloping section 54, and possibly a decorative or protective section 56, or the fabric 44 can have holes 52 cut into it after lamination but before the application of the treatment or sealing section 54 or the decorative or protective section 56 or both. It should be noted that these holes 52 can be of any shape.

The treatment or sealing section (54) can be deposited or adhered onto and envelope one or both sides of the final fabric 44 to facilitate the waterproof and breathability properties of the fabric 44. This section keeps liquid water from passing through the section but allows water vapor and other gases to move through the fabric section freely. This type of deposition is known to those skilled in the art and will not be described in detail herein. An excellent example would be the proprietary layers that WL Gore and Associates applies to fabric to make it waterproof and breathable. It should be noted that there are many alternative coatings or films to GoreTex® currently commercially available, including ThermoPlastic Urethanes such as the ones manufactured by API, Omniflex, or Noveon. The optional decorative or protective section 56 can also be added to one or both sides of the fabric 44 to change external properties of the final fabric such as texture, durability or moisture wickability. As with the fabric embodiments in FIGS. 1 and 2, the sections can have different embodiments on the same plane. For instance, a section of the charge or recharge section 50 can use photovoltaics, while another section can use piezoelectrics, or a section of the energy release plane can produce light while another section can produce heat. Similarly, one section of the plane can produce light while another section on the same plane can use photovoltaics to recharge the energy storage section. The sections can also be arranged in any order including coplanar arrangements as well as stacking arrangements, and there can be multiple instances of each section in the final fabric.

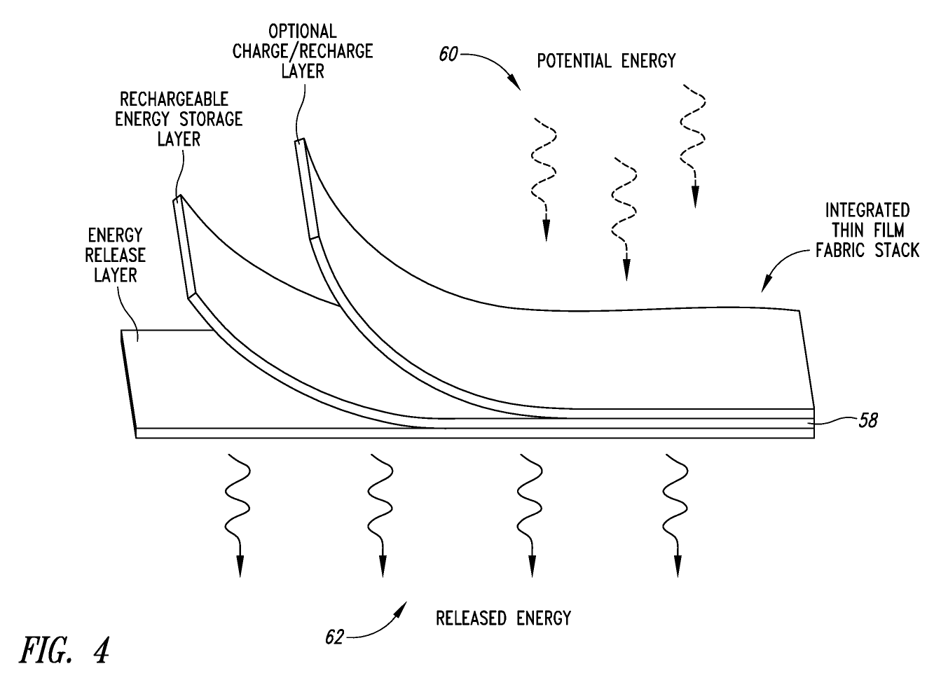

FIG. 4 illustrates a flexible, integrated fabric 58 capable of receiving surrounding energy 60 from many possible sources, converting it to electrical energy and storing it integral to the fabric, and then releasing the electrical energy in different ways 62. This illustration shows only one embodiment of the fabric sections whereas there are many possible section permutations within the embodiments described.

Integration of Energized Fabric Panel Summary

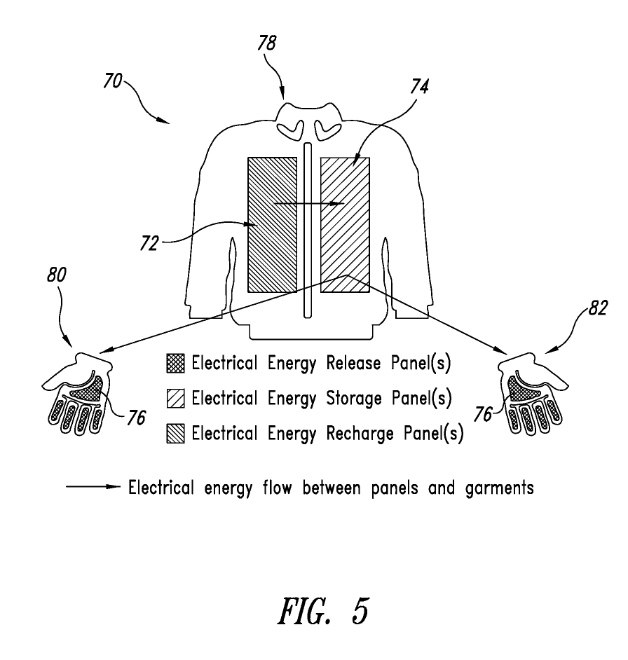

With the introduction of the energized fabric panel, which consists of a textile panel that can contain an integrated power source, integrated energy release methods, and integrated charging and control systems, there is a need for a method of incorporating this new technology into garments or accessories, i.e., a method for the integration of an energized textile panel into a garment or accessory. In one embodiment shown in FIG. 5, the energized panel system 70 consists of first, second, and third separate sections or panels 72, 74, 76, respectively, with specialized functions that are connected together via external connectors either inside a single garment or between multiple garments 78, 80, 82 to provide a complete system between the multiple garments.

For instance, an energized panel 74 that provides for electrical energy storage can be located within one garment, such as a jacket 78, and then connected via an external connector (not shown) to an energized panel 76 that provides control and release of heat energy in a different garment, such as a pair of gloves 80, 82, thereby forming a complete heating system between multiple garments. A single panel can also contain all the energized system properties, such as electrical energy storage 74, energy release 76, and a charging and control system 72, and when integrated into a single garment would incorporate the entire system into a single garment. The energized panel 76 can be sewn into a garment 78 or accessory 80, 82 with the same procedures as a normal textile panel. However, the seam must not pass through or too near certain areas of the energized panel 76 so as not to damage the internal working characteristics of the panel itself.

The energized panel can also be adhered into a garment 78 with an adhesive agent, by the use of some sort of textile welding system, by the insertion of the energized panel into pocket of the garment or accessory, or by the use of a textile friction device such as Velcro. In all of the above cases it is important that the integration scheme does not damage or impede any of the characteristics designed into the energized textile panel. The introduction of energized textile panels and their subsequent need to be integrated into larger systems creates the need for new methods of incorporation that allow the energized fabric panel to work within the garment or accessory system as intended.

Multiple Panel/Garment Control Options Summary

There is also a need for controlling one or more energized fabric layers, sections, or panels within a larger system such as a garment or accessory or for controlling layers, sections, or panels between garments or accessories. The present disclosure provides a system where, in this embodiment, multiple panels form a system that, depending on how the panels or systems of panels are connected, allows for the panels to be controlled independently or provides any panel to become the master to which other panels are slaves. Some combination of the above two situations could also exist. By having circuitry in place on each panel to allow for its independent control or for its control by another panel or system of panels, configurable control of the panels can be provided, depending on how they are connected to one another. Energized panels with a specific function like electrical energy storage or energy conversion, for instance, can be located in one garment and then connected to another energized panel with a specialized function, such as heat energy release, light emission, RF communications, etc., in another garment via an external connector, to provide a complete larger system between multiple garments.

For example, by connecting the pair of gloves 80, 82 containing energized panels 76 to the jacket 78 containing energized panels 74, control could be initiated by one of the gloves 80 over the other glove 82 and jacket 78 by the configuration of the connection between the jacket and gloves. In another instance of the same system, the control of all three garments could be done by just the jacket. In another instance of the same system all three garments could be controlled independently.

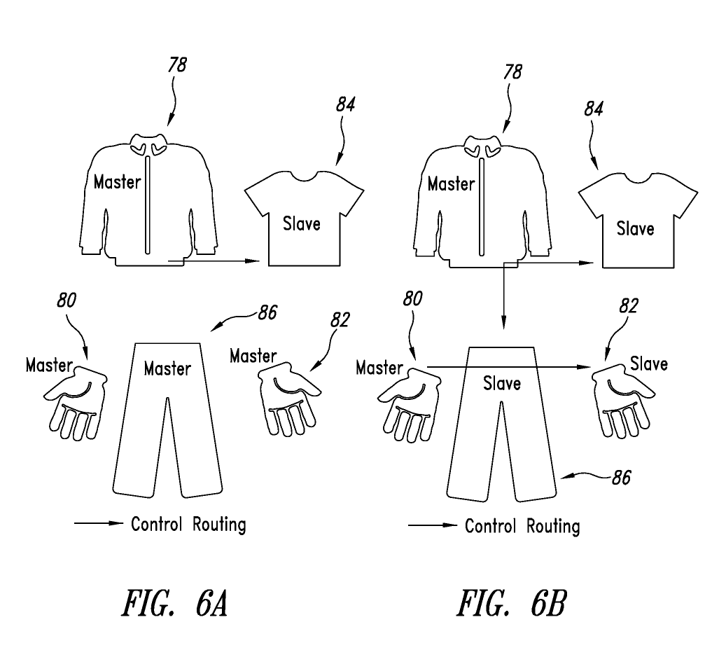

And as shown in FIG. 6A, the jacket 78 can function as a master to an accompanying shirt 84, while a pair of pants 86 and pair of gloves 80, 82 function independently as masters. Alternatively, in FIG. 6B, the jacket 78 is the master to the shirt 84 and pants 86, while the right hand glove 80 is the master to the other glove 82.

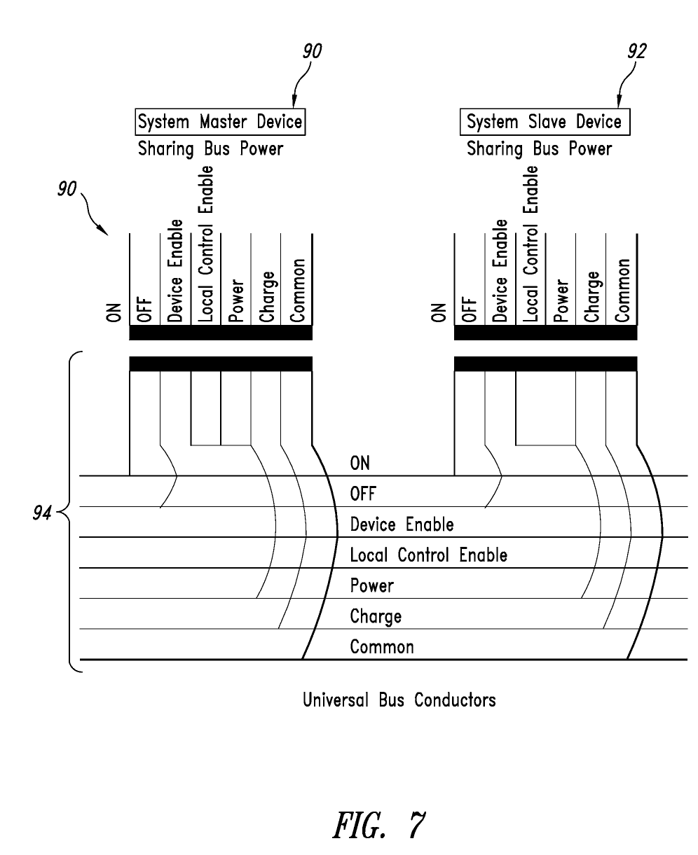

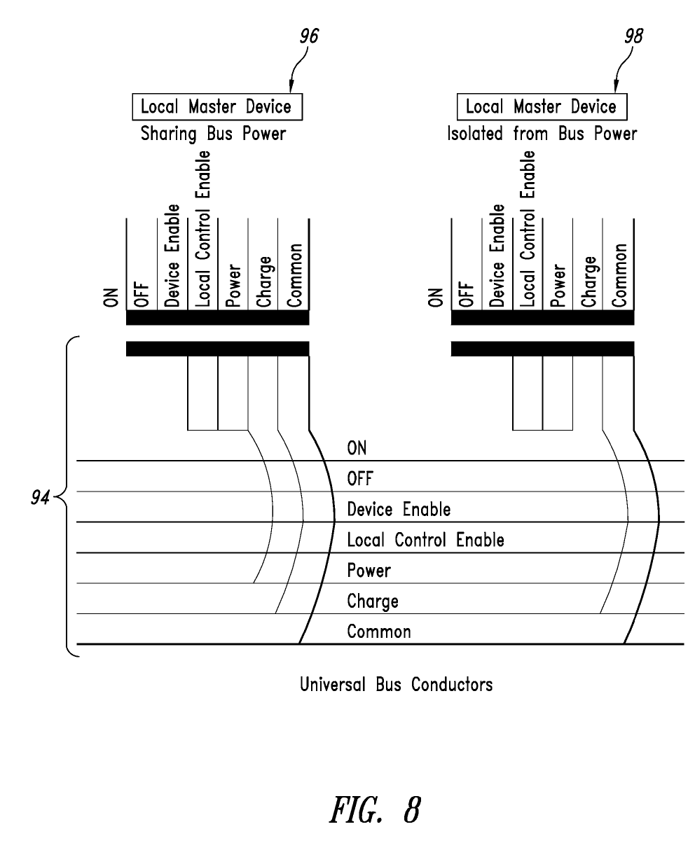

FIGS. 7-8 show the connection of electrical conductors to the devices via a system of universal bus conductors. In FIG. 7, the system 88 includes a system master device 90 and a system slave device 92 receiving electrical power and control signals, such as on, off, device enable, and local control enable via a shared bus 94. FIG. 8 shows a local master device 96 sharing bus power from the bus 94 and a local master device 98 isolated from the power of the shared bus 94.

The energized textile panels and their integration into larger systems creates the need for methods of control that provide the user a manageable, dynamic interface to ensure that when systems are coupled or decoupled, an easy and intuitive system of control is available in all cases.

Embedding Electronic Components in Film Substrates Summary

The present disclosure also provides techniques for sealing devices, such as electronic circuits, components, and electrical energy storage devices inside a highly flexible, robust laminate panel for subsequent integration into a larger system. This disclosure provides, in one embodiment, a system where the devices, such as electronic circuits, components, and energy storage devices, are embedded between laminated film substrates to form a flexible, environmentally sealed, finished laminate able to be integrated into a larger system such as a garment or accessory. The embedded circuits, components, and energy storage devices can be included in many different substrate layers within the finished laminate. The devices can also be located in separate panels and connected together via external connectors to provide a larger system. With the advent and advancement of adhesive technology, polymer technology, and new, engineered materials, it is now possible to produce a finished laminate with environmentally sealed, embedded electrical components, circuits and energy storage devices that is thin and flexible.

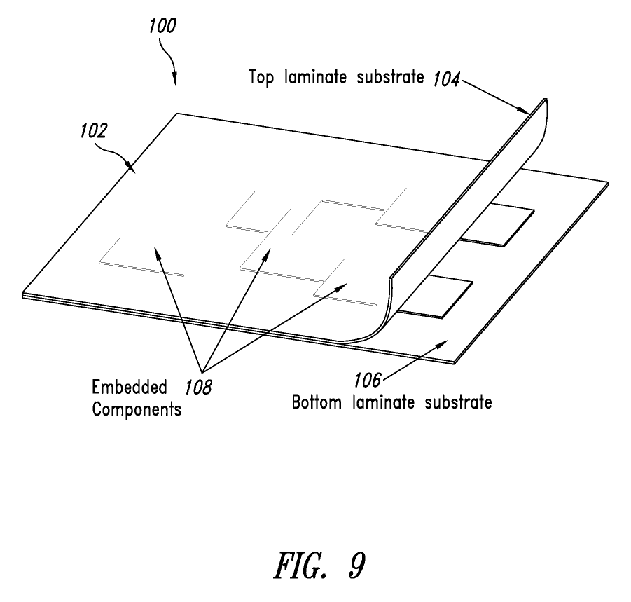

FIG. 9 shows a segment 100 of laminate material 102 having a top laminate layer 104 and a bottom laminate layer 106. Embedded between these two layers 104, 106 are devices 108, such as electrical circuits, electrical energy storage devices, electromagnetic devices, semiconductor chips, heating or cooling elements, or both, light emission devices such as incandescent lights or LED's or both, sensors, speakers, RF transceivers, antennae, and the like.

Battened Adhesive Lamination Background

There are currently many substrate or layer adhesion systems that consist of solid or patterned adhesive applied to film for the purpose of affixing the film to another object. However, there is not an adhesion system coupled with a lamination manufacturing technique for producing a single laminate that maximizes adhesive strength between the films, maximizes the MVTR properties of the finished laminate, and maintains a robust fluid barrier for the electronic components embedded between its films.

The present disclosure provides a lamination system and technique that maximizes substrate film adhesion strength and maintains a robust fluid barrier for embedded electronic components while also maximizing MVTR through the finished laminate. By using striped adhesion on the substrate layers and orienting the layers during lamination so that the adhesive strips are at an angle other than parallel to one another, the present disclosure creates a finished single laminate that is strong, highly breathable and retains a sectioned fluid barrier so embedded components are protected if the finished laminate is somehow compromised. This adhesion technique can be used with many layers of substrates to create a final laminate with many battened adhesive layers.

The adhesion can also consist of a single or multiple patterned adhesive layers as long as the resultant adhesive pattern when laminated forms a closed adhesive batten. With the advent and advancement of adhesive technology, polymer technology, and new, engineered materials, it is now possible to produce a finished laminate with the above characteristics.

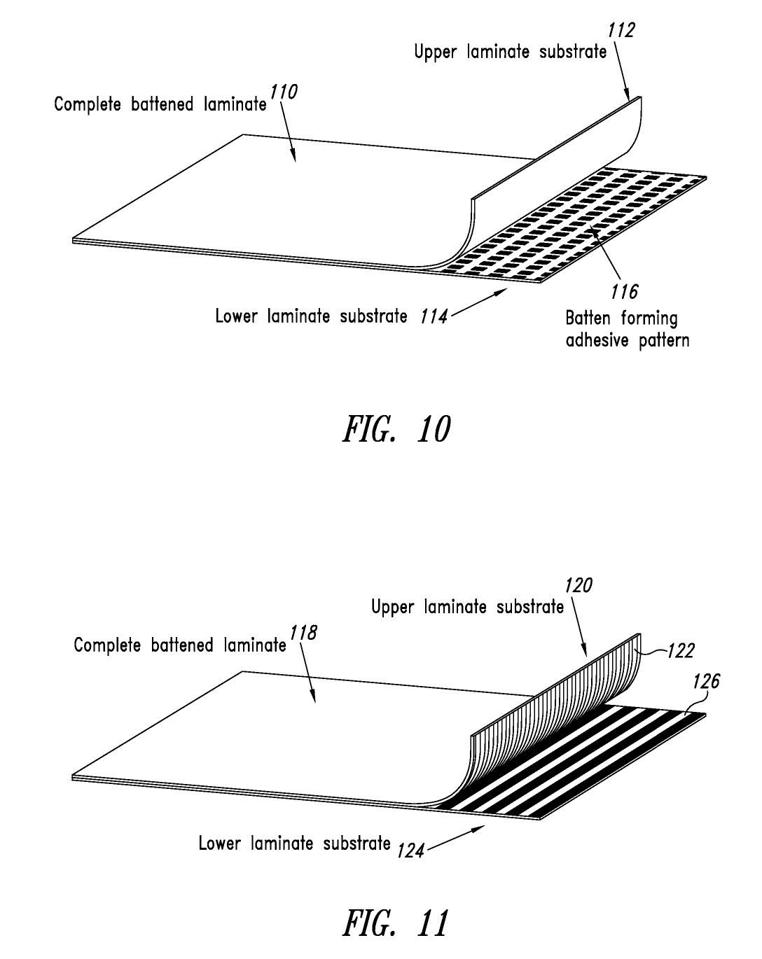

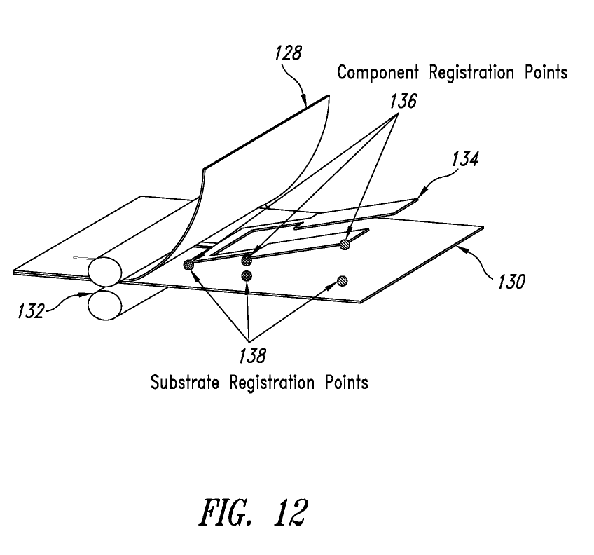

FIG. 10 shows a battened laminate section 110 with upper and lower substrates 112, 114, respectively, that are adhered together by a batten forming adhesive pattern 116 that is shown on the lower laminate substrate 114. FIG. 11 shows a complete battened laminate section 118 in which an upper laminate substrate 120 has longitudinal strips of adhesive 122 and the lower laminate substrate 124 has transverse strips of adhesive 126. When these substrates 120, 124 are pressed together, the adhesive strips 122, 126 form a batten checker board pattern.

Energized Textile Lamination Press Summary

While there are currently systems that can be used for the lamination of thin, flexible substrates around electronic circuits and components, there is no system capable of allowing an operator to place electronic circuits and components at registration points imparted to the film substrate and then initiate a lamination of the two films around the placed circuits and components to ensure no air bubbles are formed between the lamination films. The present disclosure provides a lamination system that allows the user to place devices, such as circuits and components, in a specific geometry between two film sections, panels, layers, or substrates while ensuring that no unwanted air is trapped between the laminations as the lamination occurs. The registration points can be transmitted to the substrate via light or via a physical jig that allows the embedded devices to be placed and held as the lamination process occurs.

To ensure that air bubbles are not trapped between the substrates or sections as the lamination process occurs, the contact surface of the press incorporates a curved or domed, convex deformable surface that presses air out from a single location towards the current unsealed areas while not damaging components in the current laminated areas as the entire surface receives the pressure and possibly radiant energy required to continuously laminate the panel. The introduction of energized textile panels creates the need for specific manufacturing techniques and processes that enable energized fabric panels to be mass produced with a high degree of quality.

FIG. 12 illustrates one embodiment of the present disclosure in which upper and lower layers 128, 130, respectively, are compressed together between a pair of rollers 132. It is to be understood that a single roller pressing on a support surface could also be used. An electric component 134 is placed between the two layers 128, 130 and positioned by component registration points 136 and substrate registration points 138 as described above.

From the foregoing it will be appreciated that, although specific embodiments of the invention have been described herein for purposes of illustration, various modifications may be made without deviating from the spirit and scope of the invention. For example, although a representative embodiment has been described in terms of “sections,” it is to be understood that the present invention can take the form of layers, plies, filaments, strips, belts, and the like. Accordingly, the invention is not limited except as by the appended claims and the equivalents thereof.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A flexible material, comprising:
a first flexible section configured to store energy;
a second flexible section coupled to the first section and configured to release the stored energy contained in the first section; and
a plurality of devices embedded in the material and coupled to the first section to utilize the stored energy.

2. The material of claim 1 further comprising a controller coupled to at least one of the first and second sections and further coupled to the plurality of devices.

3. The material of claim 1, wherein the material is formed of at least one from among woven strips, laminated sections, and woven coaxial sections.

4. The material of claim 1, further comprising a third section coupled to the first section and configured to receive ambient energy and to convert the ambient energy into electrical energy for storage in the first section.

5. The material of claim 4, wherein the material is formed of at least one from among woven strips, laminated sections, and woven coaxial sections.

6. The material of claim 2, further comprising a third section coupled to the first section and wherein the third section is configured to receive energy and convert the energy into electrical energy for storage in the first section or for use by the second section and the plurality of devices.

7. The material of claim 6, wherein the material is formed of at least one from among woven strips, laminated sections, and woven coaxial sections.

8. The material of claim 6, wherein the first, second, and third sections are formed to be flexible and, along with the plurality of devices, are covered with a layer so that the material has at least one of the following characteristics of breathability, moisture wickability, water resistance, waterproof, and stretchability.

9. The material of claim 6, wherein the first, second, and third sections and the plurality of devices are laminated between protective layers that are adhered together to form adhesive battens.

10. The material of claim 1, wherein the protective layers and devices are arranged to have at least one of a coplanar relationship to one another and a stacked relationship to one another.

11. A flexible garment, comprising:
a first flexible layer adapted to store electrical energy; and
a second flexible layer coupled to the first layer and configured to release the stored energy contained in the first section;
a plurality of devices in the garment adapted to utilize the electrical energy from the first layer, the devices and the second layer comprising a combination of at least two from among heat dissipation, heat generation, light emission, and an electric circuit; and
a layer formed on the first, second, and third layers along with the plurality of devices to form a single panel or multiple connected panels.

12. The garment of claim 11, wherein the layers, devices, and components are arranged to have at least one of a coplanar relationship to one another and a stacked relationship to one another.

13. The garment of claim 11, further comprising a third layer coupled to the first layer and configured to receive ambient energy and to convert the ambient energy into electrical energy for storage in the first layer.

14. The garment of claim 11, comprising a control circuit coupled to the plurality of devices and to the first, second, and third layers and adapted to provide selective control of operation of at least the second layer and the plurality of devices.

15. The garment of claim 11, wherein the garment comprises a bus coupled to the at least one panel to enable the at least one panel to perform as one of a master panel and a slave panel.

16. The garment of claim 15, wherein the garment includes at least one panel embedded in material forming the garment.

17. The garment of claim 16, wherein the garment comprises multiple panels coupled to a bus to enable distribution of energy to at least one of the panels.

18. The garment of claim 11, wherein the material comprises a plurality of substrate layers laminated with battened adhesive layers.

19. The material of claim 18, wherein the material is formed of at least one from among woven strips, laminated sections, and woven coaxial sections.

20. A method of providing a flexible fabric material adapted to be formed from a first flexible layer adapted to store electrical energy and a second flexible layer electrically coupled to the first flexible layer and adapted to receive the stored energy from the first flexible layer for use in at least one from among heat dissipation, heat generation, light emission, and powering of an electric circuit, the method comprising: laminating at least one device and the first and second layers with at least one lamination layer.

21. The method of claim 20 wherein the flexible fabric includes a third layer configured to convert energy for storage in the first layer, and wherein the step of laminating comprises laminating the third layer within the protective layers.

22. The method of claim 21, comprising utilizing a system of registration to place the at least one device and the first, second, and third layers in a specific geometry.

23. The method of claim 21, comprising utilizing at least one roller to laminate the layers, the roller having a surface geometry adapted to remove air from between the layers as the lamination process occurs and to not damage the embedded components and the layers.

24. The method of claim 21, comprising adhering the layers together in a manner that forms adhesive battens within the laminate.

25. The method of claim 20, comprising arranging the first and second layers and the components to have at least one of a coplanar and a stacked relationship to one another.

26. A device, comprising:
a first flexible layer adapted to store electrical energy;
a second flexible layer coupled to the first layer and configured to release the stored energy in the first layer; and
a plurality of devices adapted to utilize the electrical energy from the first layer, the devices and the second layer comprising a combination of at least two from among heat dissipation, heat generation, light emission, and an electric circuit;
a layer that covers the first and second layers along with the plurality of devices coupled to at least one of the second layer and the first layer to form at least one of a single panel and multiple connected panels; and
a bus to enable distribution of energy to at least one of the panels in the garment.

27. The device of claim 26, comprising a third layer coupled to the first layer and configured to receive ambient energy and to convert the ambient energy into electrical energy for storage in the first layer.

28. The device of claim 26, comprising a connection of multiple panels to form a connected system through the bus.

29. The device of claim 26, comprising a connection of multiple garments to form a connected system through the bus.

30. A garment system, comprising:
a plurality of garments, each garment having at least a portion thereof formed of:
a first flexible section adapted to store electrical energy;
a second flexible section coupled to the first section and configured to release the stored energy contained in the first section;
at least one device in at least one garment adapted to utilize the electrical energy from the first section, the at least one device and the second section comprising a combination of at least two from among heat dissipation, heat generation, light emission, and an electric circuit;
a layer that covers the first and second sections along with the at least one device to form at least one of a single panel and a plurality of panels that are connected together; and
a bus coupled to the at least one of a single panel and the plurality of panels to enable the at least one of a single panel and the plurality of panels to perform as one of a master panel and a slave panel and to enable sharing of electrical energy among the garments.

31. The garment system of claim 30, comprising a local control device in each garment adapted to enable selection of a mode of operation of the associated garment apart from other garments in the system.

32. The garment system of claim 30, wherein each garment is formed of material that comprises at least one from among woven strips, laminated sections, and woven coaxial sections.
